(19) United States
(12) Patent Application Publication
(10) Pub. No.: US 2004/0044776 A1
(43) Pub. Date: Mar. 4, 2004

(54) Peer to peer file sharing system using common protocols

(75) Inventor: Michael Kevin Larkin, San Jose, CA (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: INTERNATIONAL BUSINESS MACHINES CORPORATION

(21) Appl. No.: 10/104,743

(22) Filed: Mar. 22, 2002

(51) Int. Cl. G06F 15/16

(52) U.S. Cl. 709/228

(57) ABSTRACT

There is provided a method for exchanging data between a first device and a second device via a network. The method includes (a) communicating a request for the data from the second device to the first device, (b) communicating an identifier for the data from the first device to the second device, (c) communicating the identifier from the second device back to the first device, and (d) communicating the data from the first device to the second device, after the communication of the identifier from the second device back to the first device. The request, the identifier, and the data are formatted in accordance with a protocol that is common to both of the first device and the second device. There is also provided a system for a first device to exchange data with a second device via a network.

### BACKGROUND OF THE INVENTION

1. Field of the Invention

The present invention relates to file-sharing across a computer network, and more particularly, to a file-sharing arrangement in which a local system and a remote system engage with one another in a peer-to-peer relationship.

2. Description of the Prior Art

Computer networking and, in particular, connectivity to “the web” via the Internet, has enabled many individuals and businesses to participate in the “online” world, and telecommuting is becoming more commonplace. A satisfactory telecommuting experience usually requires a transfer of files or other data between a first computer local to a user and second computer or memory system at a remote location.

Conventional protocols for transferring data include (a) server message block (SMB), which is used by many Windows™ clients, (b) network file system (NFS), which is used by many UNIX™ variants, and (c) file transfer protocol (FTP), which is a relatively crude file exchange method available on many hardware platforms. Conventional protocols also include attaching data to e-mail. These conventional protocols are not universally employed because many corporate firewalls block data sent by a system that uses these protocols. Also, these protocols may have network topology constraints that limit their usefulness from remote locations (e.g., remote, roaming or telecommuting users) unless invasive changes are made to a user's computer. On the other hand, such firewalls nearly always allows web traffic, which uses hyper-text transfer protocol (HTTP) as its underlying protocol, to pass unmolested.

However, none of these conventional protocols provide adequate flexibility for their employment in a robust telecommuting or remote computing environment. For example, SMB requires a WINS server for cross-subnet operation, and when implemented as a Windows™ “network neighborhood it cannot interface with a UNIX™ SMB, e.g., Samba, without registry patches on the Windows™ client. NFS, which is a UNIX™ network file system, requires costly client software for integration into a Windows™ environment. E-mail attachments are cumbersome to use when many files are to be transferred.

Another system currently in use for peer to peer file sharing is Gnutella. Gnutella is a mini search engine and file transfer system. The actual file sharing is performed using HTTP, while the search is performed using a Gnutella-proprietary protocol. There is no program called “Gnutella”, instead, the term refers to a protocol used by various Gnutella-compliant client programs. With Gnutella clients, users of the Gnutella network can search for files shared by other users. Once a match is located, a file transfer is initiated between the interested parties.

Gnutella, as described in “Gnutella Protocol Specification v0.4”, requires a primary connection to be established between Gnutella servants. This connection must be made over standard Transmission Control Protocol/Internet Protocol (TCP/IP) channels to a predetermined TCP port. It is unclear whether this would require a second port to be available, that is a first port for Gnutella search queries and a second port for HTTP file transfers. If a second port is required, it would imply that not only HTTP traffic is allowed to pass unmolested between participants, but that Gnutella traffic over the aforementioned TCP port would be allowed to flow unmolested as well. This may not be possible in a highly secure environment.

With the current set of Gnutella clients, one has to use a search engine, which behaves in a similar capacity to other search engines, such as Napster™, to locate desired files, and then initiate manual transfers of the desired files. Consider a case of a user who is sharing music files with a stranger using Gnutella. Once the stranger locates and transfers the music files that the stranger desired from the remote user, there is typically no need for the stranger to re-download these music files again. Hence, the need for tight integration with the operating system (OS) to manipulate and query these files is not needed, since music files and other media files commonly transferred over Gnutella are static and generally do not change over time.

Gnutella is a search-then-share system. Gnutella clients do not appear to be capable of providing, and they typically do not appear to have a need for, seamless client OS integration. For example, since Gnutella is a search-then-share system, there is typically no need for a Gnutella client to have a drive letter (on a Windows™ computer) or mount point (on a UNIX™ system) mapped to any particular set of files.

Traditional file sharing systems, including protocols such as Gnutella or products such as Napster™, cannot ordinarily be integrated into a user's operating system and, because of this limitation, are not ordinarily transparent to a native application running on the user's computer. Instead, traditional file sharing systems rely on a proprietary interface to search for, find, and subsequently transfer the files desired. Protocols such as FTP are similarly restricted, sometimes relegated to command line interfaces or other non-seamless graphical user interface (GUI) front-ends.

### SUMMARY OF THE INVENTION

The present invention to provides an improved method and system for sharing data between computers where the computers use a common protocol to exchange the data. The present invention also prevents unauthorized access to the shared data, and allows for a third party to authorize or deny a transfer of the data between the computers.

A first embodiment of the present invention is a method for exchanging data between a first device and a second device via a network. The method includes (a) communicating a request for the data from the second device to the first device, (b) communicating an identifier for the data from the first device to the second device, (c) communicating the identifier from the second device back to the first device, and (d) communicating the data from the first device to the second device, after the communicating the identifier from the second device back to the first device. The request, the identifier, and the data are formatted in accordance with a protocol that is common to both of the first device and the second device.

A second embodiment of the present invention is a method for exchanging data between a first device and a second device via a network. The method includes (a) communicating a status packet from the second device to the first device, (b) communicating a reply to the status packet from the first device to the second device, wherein the reply includes a request for the data, and (c) communicating the data from the second device to the first device, after the communication of the reply. The status packet, the reply and the data are formatted in accordance with a protocol that is common to both of the first device and the second device.

A third embodiment of the present invention is a method for exchanging data between a first device and a second device via a network. The method includes (a) communicating a status packet from the second device to the first device, (b) communicating a reply to the status packet from the first device to the second device, wherein the reply includes a request for the data, (c) communicating an identifier for the data from the second device to the first device, (d) communicating the identifier from the first device back to the second device, and (e) communicating the data from the second device to the first device, after the communicating of the identifier from the first device back to the second device. The status packet, the reply, the identifier, and the data are formatted in accordance with a protocol that is common to both of the first device and the second device.

The present invention also encompasses systems and storage media for controlling a processor to employ the aforementioned methods.

### BRIEF DESCRIPTION OF THE DRAWINGS

FIG. 1 is a block diagram of a system configured for employment of the present invention.

FIG. 2 is a block diagram of a functional hierarchy of the present invention employing HTTP protocol.

FIG. 3 is a block diagram of a functional hierarchy of the present invention employing a user defined, user supplied, and protocol.

FIG. 4 is a block diagram of a functional hierarchy of the present invention employing SOAP protocol over various lower-level protocols.

### DESCRIPTION OF THE INVENTION

The present invention provides for a method and system for sharing of data or files between two computer systems that use a common protocol. When a common protocol is used, restrictions relating to a client operating system, client hardware platform and client software that might otherwise interfere with data sharing are overcome. In a case of a local user accessing data from a remote system, the relationship between the local user and the remote system is a peer-to-peer relationship, rather than a conventional client-server relationship.

Client/server networking, in a strict sense, means that one system provides a service of some sort and another system, or perhaps multiple systems, consumes the service. The service provided could be file storage, database queries, authentication services, or any number of other services. Traditional client/server systems initially filled the need of housing and managing large amounts of data centrally. Instead of each user housing and managing its own data, the data and access controls on the data were stored on a central server where administrators could monitor a single system and ensure that service was not interrupted. This was the norm for many years until users began setting up their own networks at home and small office networks at work. It became desirable at that point for data sharing between these users without the need for a large server and administrative team.

Peer-to-peer networking is an alternative to client/server networking. Peer to peer networking implies that all participants are “equal”. In other words, no single entity has to act as a “server” and provide service to the other users of the network. Instead, all users of the system act as mini-servers, providing service (usually sharing data and other files) but not having to maintain the overhead of server management in the traditional sense, as described above. In addition, the participants of a peer-to-peer system also act as clients, consumers of service, of other systems in the network. In a sense, in a peer-to-peer environment, everyone is both a client and a server, although not necessarily a server all the time, e.g., consider a case where there is no data to be “served”, and not necessarily a client all the time, e.g., when a particular user is only “serving” data and not consuming services from other peers.

In its preferred embodiment, a system in accordance with the present invention uses commonly proxied HTTP to transfer the data. Most corporate firewalls and other Internet blocks allow passage of data transmitted in accordance with HTTP, and so, for example, such data can pass seamlessly from a corporate server to an employee or a contractor outside a corporate network. The present invention uses HTTP in a manner similar to that of a web browser or a web server, and as such, corporate firewalls and other Internet blocks allow passage of its traffic as well. Thus, in its preferred embodiment, the system provides for peer-to-peer sharing of files and other data, using HTTP as an underlying transfer protocol.

A refinement of the present invention is an integration of a software module inside a device driver or file system driver that can be loaded into a user's operating system. This provides for a transparent use of the present invention by native software applications installed on the user's workstation. Native applications then need not be rewritten. In addition, a transparent mapping of data, that is, transparent to the user's operating system and native applications, allows native searching and indexing utilities to be used against the shared data. For example, the device driver could map a drive letter, or simulate a mount point. Thus, a local user of a system in accordance with the present invention can access remote corporate data in a manner similar to that of accessing local data by accessing the drive letter or mount point.

Security is a major concern in a networked environment. To address security concerns, the present invention uses an encryption algorithm to ensure that data integrity is not compromised and to ensure that there is no opportunity for eavesdropping by an outside entity.

The present invention employs a security framework that prevents unauthorized access to shared data. This security framework makes authentication decisions using one or more of several techniques. For example:

(1) The system can make use of a security module present on the user's operating system to authenticate a foreign user.

(2) The system can use a public key/private key to authenticate a foreign user.

(3) The system can use an access control list (ACL) to authenticate a user based on simple rules such as a common name or an Internet protocol (IP) address.

The security framework also allows for a third party to authorize a file transfer such that the third party can approve or reject the sharing of data between two users. This third-party authorization method is available in two embodiments. In the first embodiment, the third party is a security authority (SA) that acts as a centralized security manager. All access between users must authenticate to the SA, and the SA distributes security keys that allow the users to share files. In the second embodiment, the SA acts as a security inspector, and grants or denies sharing based on metadata about the files being shared and the two users. Security keys are shared directly by the two users.

The present invention also contemplates a configuration tool that can be employed by a user to perform administrative tasks. For example, the user can (a) define which data on a local workstation is to be shared, (b) create, i.e., mount, a remote share from another user's workstation, and (c) manipulate security access controls on shared data.

Note that the terms “local” and “remote” are used herein to distinguish between devices from the perspective of a generic user. That is, from the perspective of the user, one of the devices is a local device, and the other device is a remote device. However, the present invention does not require any specific geographic or spatial positioning of the devices.

An “apparatus” in accordance with the present invention is a combination of hardware and software, typically embodied in, or associated with, a device, such as a workstation, coupled to a network. The term “communicating” can mean either “transmitting” or “receiving” depending on the perspective of the apparatus or the perspective of the device that is performing the communicating. For example, consider the phrase “communicating data from a first device to a second device.” If the apparatus is embodied within the first device, the phrase means “transmitting data from the first device to the second device.” On the other hand, if the apparatus is embodied in the second device, the phrase means “receiving data from the first device at the second device.”

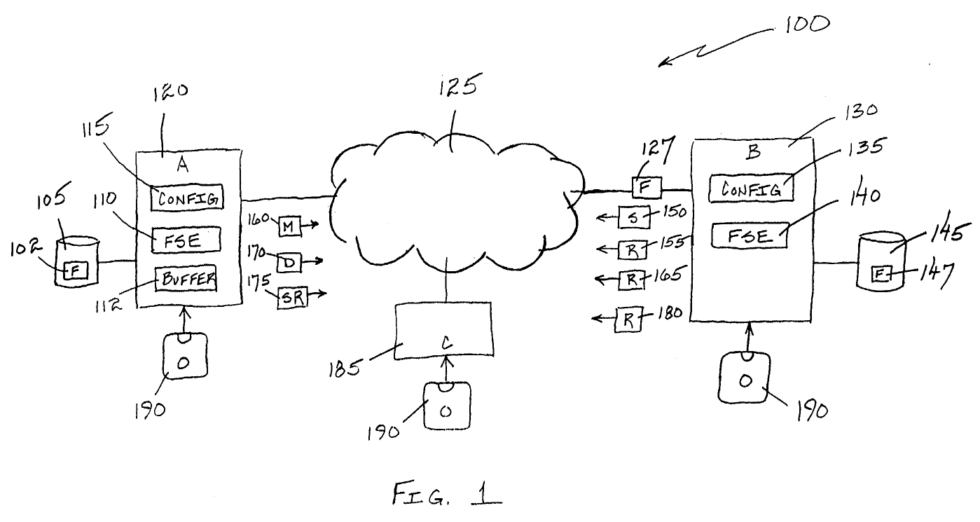

FIG. 1 is a block diagram of a system 100 configured for a first device, e.g., a local device, to exchange data with a second device, e.g., a remote device, via a network in accordance with the present invention. The data can represent any form of text, graphics, video or audio information.

System 100 includes two workstations 120, 130 configured for communication with one another via a network 125. As mentioned earlier, the meaning of the terms “local device” and “remote device” depend on one's perspective. As such, either of workstations 120, 130 may be regarded as the local device, and then the other would be regarded as the remote device.

Network 125 can be any of a local area network (LAN), a wide area network (WAN), or a combination of networks, such as a corporate intranet coupled to the Internet. Workstations 120, 130 can connect to network 125 via a wire conductor, an optical link or a wireless link.

Workstations 120, 130 are meant to include any processor or device configurable for exchanging data with another processor or device via network 125. By way of example, such a processor or device can be a general purpose microcomputer, such as one of the members of the Sun™ Microsystems family of computer systems, one of the members of the IBM Personal Computer family, or any conventional work-station or graphics computer device, a desktop computer, a laptop computer, or a personal digital assistant. Workstation 120 has an affiliated local storage device 105, and workstation 130 has an affiliated local storage device 145. In their preferred embodiment, storage devices 105 and 145, are disk storage media.

Workstation 120 also includes a buffer 112, the purpose of which is described below. Buffer 112 is a data storage device. It can be implemented, for example, as a random access memory (RAM) and located either internal to workstation 120, as shown in FIG. 1, or external to workstation 120. Alternatively, it can be implemented as part of a storage system such as storage device 105, or on another storage system such as a separate disk drive.

A software program module within which the present invention is embodied is installed in a memory on each of workstations 120 and 130. The software module includes instructions for execution by the processors within workstations 120 and 130 to implement a configuration tool 115, 135 and a file-sharing engine (FSE) 110, 140, as described herein.

Consider a case of two users “A” and “B”, in this example two people. User A has workstation 120 and user B has workstation 130. In one embodiment of the present invention, a simple model using minimal security, a typical transaction might proceed as follows:

(1.1) At some point in time, A decides to share a file 102 with B.

(1.2) A uses configuration tool 115 to mark file 102 as shareable, and to permit B's access to file 102.

(1.3) A's configuration tool 115 notifies A's FSE 110 of the new permission and share information as defined in step 1.2.

(1.4) At some point, B uses configuration tool 135 to create a local reference to A's share, that is, to create a local reference on B's workstation 130 to A's file 102.

(1.5) B's FSE 140 authenticates to A's FSE 110 using a suitable security mechanism. That is, B's FSE 140 provides some appropriate security information to A's FSE 110 in order to identify B as having authorization to access file 102.

(1.6) A communication link is established between B's FSE 140 and A's FSE 110 across network 125. B's FSE 140 establishes a connection to A's FSE 110. B's FSE 140 sends A's FSE 110 a status packet 150, i.e., a “heartbeat” packet, at periodic, preferably regular, time intervals, until the communication link is terminated. In return, A's FSE 110 sends a status packet reply 175 to B's FSE. This round-trip exchange of status packet 150 and status packet reply 175 allows both A's FSE 110 and B's FSE 140 to recognize whether the other is “online”, and conversely to recognize whether the other is not connected to the network and/or to determine link congestion. Since a slow reverse link could skew the transit time of a packet, there may be situations where one wishes to consider a one-way transit time. For example, travel time of status packet 150 can be used to determine quality and congestion of network 125.

(1.7) File access is passed through B's FSE 140 when B makes a request for data from file 102 or when one of B's local software applications attempts to access a remote reference or drive letter/mount point, which is mapped to A's workstation 120 at the time of the request.

(1.8) At B's FSE 140, the request for data in step 1.7 is translated into an HTTP request 155 and sent to A's FSE 110. HTTP request 155 includes relevant information such as a file name and an indication of which data block is being requested.

(1.9) A's FSE 110 decodes HTTP request 155 and sends a marker packet 160 to B's FSE. Marker packet 160 can be encoded as an HTTP cookie or it can be encoded using some other suitable encoding technique. A cookie is typically a small packet of information sent from one party to another party to be retrieved at a later time by the sending party. Marker packet 160 contains an identification number that B's FSE 140 stores on local storage device 145 for use in future communications.

(1.10) A's FSE 110 reads B's requested data from A's local shared file 102 and encodes this data in an HTTP-suitable format. This encoded data is stored in a buffer 112 local to A's workstation 120, and marked with an identification matching that of marker packet 160, which was sent to B's FSE 140 in step 1.9. At some point, B's FSE 140 sends a second request, i.e., a request 165, to A's FSE 110 containing the identification for marker packet 160 and a request for retrieval of the data previously stored in buffer 112. By buffering the encoded data in buffer 112, it is possible to cache future requests for the same data, and also, if for some reason there is corruption on the link, it is possible for the requestor to re-request the data by resubmitting the same marker. This marker/buffering is described below in greater detail. Note that in some circumstances A's workstation 120 cannot initiate a connection to B's workstation 130, but once a connection is established from B's workstation 130 to A's workstation 120, A's workstation 120 can send data over the connection. Accordingly, A's FSE 110 does not send the encoded data directly back to B's workstation 130 because it cannot be assumed that A's workstation 120 can reach B's workstation 130.

(1.11) A's FSE 110 receives request 165 and validates the marker packet identification included therein against a list of outstanding marker identifications. If the marker packet identification is valid, the data stored in buffer 112 is encoded in an HTTP-suitable format and sent as a data packet 170 to B's FSE 140.

(1.12) If more data packets are required by B's FSE 140 from A's FSE 110 to fulfill the request for data in step 1.7, then steps 1.7-1.11 are repeated as necessary. The data block stored in buffer 112 by A's FSE 110 in step 1.10 is saved for a period of time to allow a retransmission of the data block if a network outage or other error, such as a data checksum error, occurs.

(1.13) Assume that B's local storage device 145 contains a file 147 that user A is permitted to access. In situations where A's workstation 120 cannot initiate a connection to B's workstation 130, the periodic transmission of status packet 150 from B's FSE 140 to A's FSE 110 (see step 1.6), can be used for A's FSE 110 to request data from B's FSE 140. For example, B's workstation 130 may be located behind a component that blocks unsolicited incoming data, e.g., a firewall 127, and as such, would block a transmission from A's workstation 120. Status packet 175 includes a field within which a file request from A's workstation to B's workstation can be encoded. This permits system 100 to operate in an environment that only permits one-way communications channel initiations, as is the case for certain types of firewall software.

(1.14) When B's FSE 140 finds that status packet reply 175 includes a request by A's FSE 110 for data from file 147, a sequence of steps similar to 1.51.12 is used to send data from B's FSE 140 to A's FSE 110. However, B's FSE 140, instead of holding data locally and waiting for a retrieval request from A's FSE, sends an HTTP encoded request 180 to A's FSE 110 that contains data blocks requested by A's FSE 110, along with a data checksum.

As described in steps 1.1-1.14, B's workstation 130 initiates a communication session by sending a status packet 150 to A's workstation 120. However, this description is only exemplary, as it is possible for A's workstation 120 to initiate the session if the roles of the workstations are reversed, or if true bi-directional initiation is allowed.

If A's FSE 110 determines that a threshold number of lost status packets is reached, then it purges data from buffer 112, and the marker packet identification, that corresponds to the lost status packets. If B's FSE 140 determines that a threshold number of lost status packets is reached, then it purges the marker packet identification that corresponds to the lost status packets. Users A and B may receive an error message on their respective workstations or on an operator panel.

System 100 may employ encryption technology to protect the integrity of data being transferred between workstations 120 and 130 via network 125. For example, in step 1.11, FSE 110 may encrypt data contained within data packet 170, and in step 1.14, FSE 140 may encrypt data contained within HTTP encoded request 180.

Authentication could be performed by a third party 185 at various times during the operation of system 100. Third party 185 may be implemented as a workstation in a manner similar to that of workstations 120, 130. Third party 185 includes a processor with an associated memory that holds a program module containing instructions for executing security features for system 100. In one embodiment, in step 1.5, third party 185 could perform the authentication of B's FSE 140 to A's FSE 110. This is known as key-pair authentication and is common in encryption technology.

In another embodiment, in steps 1.11 and 1.14, third party 185 intervenes to inspect some or all of the data transmissions between A's FSE 110 and B's FSE 140. This is known as metadata based inspection. In this scheme, third party 185 inspects characteristics of subject data, such as filename, content type, checksum, date, etc. and, based on some rule, decides whether a transfer of the subject data between A's workstation 120 and B's workstation 130 should be allowed or denied.

System 100 employs a security framework that affords a system designer considerable latitude when integrating the system within a given environment. A simple authentication mechanism consists of a basic rule based ACL as mentioned earlier. A second, more robust implementation involves an exchange of security keys between participants. This also grants the ability to use a third party authentication scheme, which would not be necessary under the ACL-based scheme.

Although system 100 is described herein as having the instructions for the method of the present invention installed into the memories of workstations 120, 130 and third party 185, the instructions can reside on an external storage media 190 for subsequent loading into workstations 120, 130 and third party 185. Storage media 190 can be any conventional storage media, including, but not limited to, a floppy disk, a compact disk, a magnetic tape, a read only memory, or an optical storage media. Storage media 190 could also be a random access memory, or other type of electronic storage, located on a remote storage system and coupled to workstations 120, 130 and third party 185.

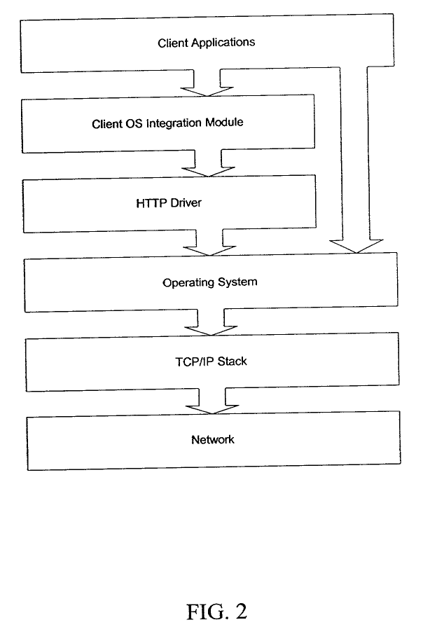

FIG. 2 is a block diagram of a functional hierarchy of one embodiment of a system, in accordance with the present invention, employing HTTP protocol. With regard to the directionality of communication between two participants, when viewed from a purely functional sense, the present invention only requires an ability for one-way unmolested communication initiation between the two participants. HTTP is the preferred communications protocol because of the aforementioned benefits, such as the prevalent policy of allowing HTTP (web) traffic to flow through corporate firewalls and other Internet blocks. The system includes a client application, a client OS integration module, an HTTP driver, an operating system, a TCP/IP stack and a network. The operating system, TCP/IP stack and network operate in a conventional manner.

The client application can be any generic software application running on either of A's or B's workstations. Examples of such generic software include Microsoft Word™, Microsoft Excel™, etc. The client application interfaces with the client OS integration module when a request is made for data stored on a drive letter or mount point.

The client OS integration module interfaces with a protocol driver that is responsible for formulating the packets and requests described earlier. The protocol driver module uses features of the operating system to send network packets and requests over the network. The client OS integration module also provides a drive letter mapping or directory mount point to files located at a remote site. For example, A's workstation 120 would use this module to map a drive letter, e.g., J:\, to reflect the files that are available on B's workstation 130. Without such a module, a user at workstation 120 would need to search and then transfer or copy files of interest from workstation 130. Thus, the client OS integration module provides the aforementioned seamless integration with the operating system.

The HTTP driver receives requests from the client OS integration module and translates the requests into HTTP format. It then uses the operating system's native technology to send messages from workstation 120 to workstation 130, or vice versa.

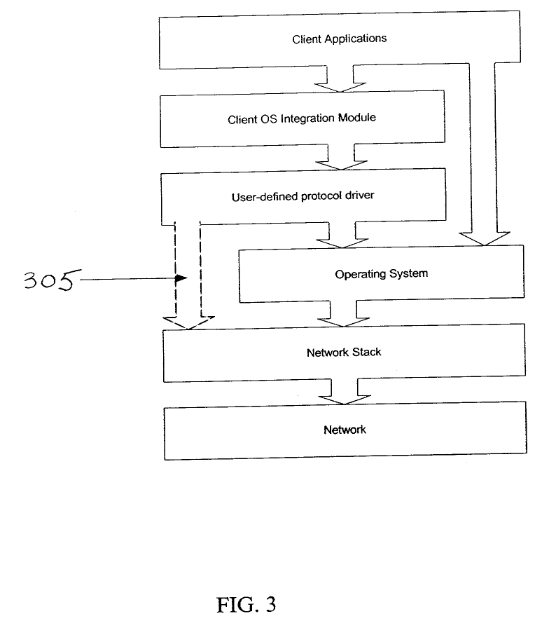

FIG. 3 is a block diagram of a functional hierarchy of the present invention employing a user defined, user supplied, protocol. FIG. 3 illustrates an alternate scenario to that of FIG. 2 using a user-defined protocol that is forwarded and unmolested in the particular environment. The hierarchy of FIG. 3 differs from that of FIG. 2 in the way the data is formulated and sent across the network link. As shown in FIG. 3, depending on the particular user-defined protocol being used, it is possible that the client operating system (OS) may be bypassed via path 305 when the protocol interfaces with the network stack. One protocol that could be used in accordance with the hierarchy shown in FIG. 3 is Remote Procedure Call (RPC), for example, but others also exist.

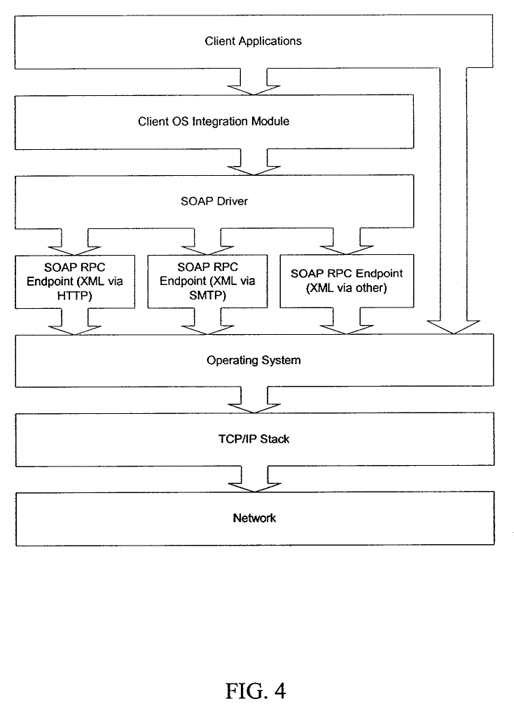

FIG. 4 is a block diagram of a functional hierarchy of the present invention employing Simple Object Access Protocol (SOAP) over various lower-level protocols. SOAP is a protocol in which a remote procedure call (RPC) can be characterized as an XML message and dispatched to a remote server. Since this scheme is RPC-based, the parameters in the procedure call include the various packets involved in the exchange, such as the status packet, the status reply packet, data packets, etc. Because SOAP itself relies on an underlying protocol, the present invention can employ SOAP over HTTP, SOAP over SMTP, or SOAP over any other suitable protocol.

The present invention integrates seamlessly with a client OS, for example, by providing a drive letter or mount point to the client. This feature is represented in FIGS. 2-4 by a block denoted “Client OS integration module”. A local user would not have to use a search engine, and instead the local user would be able to browse files available at a remote location in a standard file explorer window.

The status packet, i.e., status packet 150 in FIG. 1, is a specially formulated HTTP request. This packet is periodically sent at some time interval, preferably a regular time interval, from a requester of data to a provider of the data. The interval of time does not necessarily need to be firmly fixed, but rather, the time interval between two consecutive status packets should be less than some predetermined time interval so that each of workstations 120 and 130 will recognize that the other is “online”. The interval can be specified at compile-time. In one embodiment the interval is 60 seconds. The status packet serves a number of purposes:

(1) It directly provides for an ability for multiplexed two-way sharing of files over a link that can only be initiated in one direction.

(2) It is used by one end of a link to determine whether the other end of the link is still connected.

(3) Timestamp information in the status packet can be used to diagnose link quality by checking transit time of the status packets across the network.

(4) It provides the mechanism for file system metadata propagation, such as when files shared on the provider end are added or deleted.

It should be understood that various alternatives and modifications of the present invention can be devised by those skilled in the art. The present invention is intended to embrace all such alternatives, modifications and variances that fall within the scope of the appended claims.

What is claimed is:

1. A method for exchanging data between a first device and a second device via a network, said method comprising:
communicating a request for said data from said second device to said first device;
communicating an identifier for said data from said first device to said second device;
communicating said identifier from said second device back to said first device; and
communicating said data from said first device to said second device, after said communicating of said identifier from said second device back to said first device,
wherein said request, said identifier, and said data are formatted in accordance with a protocol that is common to both of said first device and said second device.

2. The method of claim 1, further comprising, prior to said communicating said data, authenticating that said second device is authorized to access said data.

3. A method for exchanging data between a first device and a second device via a network, said method comprising:
communicating a status packet from said second device to said first device;
communicating a reply to said status packet from said first device to said second device, wherein said reply includes a request for said data; and
communicating said data from said second device to said first device, after said communicating said reply,
wherein said status packet, said reply and said data are formatted in accordance with a protocol that is common to both of said first device and said second device.

4. The method of claim 3, further comprising periodically communicating said status packet from said second device to said first device.

5. The method of claim 3, further comprising, prior to said communicating said data, authenticating that said first device is authorized to access said data.

6. An apparatus for exchanging data between a first device and a second device via a network, said apparatus comprising:
a module for communicating a request for said data from said second device to said first device;
a module for communicating an identifier for said data from said first device to said second device;
a module for communicating said identifier from said second device back to said first device; and
a module for communicating said data from said first device to said second device, after communicating said identifier from said second device back to said first device,
wherein said request, said identifier, and said data are formatted in accordance with a protocol that is common to both of said first device and said second device.

7. The apparatus of claim 6, further comprising a module for authenticating that said second device is authorized to access said data.

8. The apparatus of claim 6, wherein (a) said module for communicating said request, (b) said module for communicating said identifier from said first device to said second device, (c) said module for communicating said identifier from said second device back to said first device, and (d) said module for communicating said data, are components of an operating system.

9. The apparatus of claim 6, wherein said protocol comprises a hypertext transfer protocol (HTTP).

10. An apparatus for exchanging data between a first device and a second device via a network, said apparatus comprising:
a module for communicating a status packet from said second device to said first device;
a module for communicating a reply to said status packet from said first device to said second device, wherein said reply includes a request for said data; and
a module for communicating said data from said second device to said first device, after communicating said reply,
wherein said status packet, said reply and said data are formatted in accordance with a protocol that is common to both of said first device and said second device.

11. The apparatus of claim 10, further comprising a module for periodically communicating said status packet from said second device to said first device.

12. The apparatus of claim 10, further comprising a module for authenticating that said first device is authorized to access said data.

13. The apparatus of claim 10, wherein (a) said module for communicating said status packet, (b) said module for communicating said reply, and (c) said module for communicating said data, are components of an operating system.

14. The apparatus of claim 10, wherein said protocol comprises a hypertext transfer protocol (HTTP).

15. A storage media that contains instructions for controlling a processor to exchange data between a first device and a second device via a network, said storage media comprising:
a module for controlling said processor to communicate a request for said data from said second device to said first device;
a module for controlling said processor to communicate an identifier for said data from said first device to said to said second device;
a module for controlling said processor to communicate said identifier from said second device back to said first device; and
a module for controlling said processor to communicate said data from said first device to said second device, after communicating said identifier from said second device back to said first device,
wherein said request, said identifier, and said data are formatted in accordance with a protocol that is common to both of said first device and said second device.

16. The storage media of claim 15, further comprising, a module for controlling said processor to authenticate that said second device is authorized to access said data.

17. A storage media that contains instructions for controlling a processor to exchange data between a first device and a second device via a network, said storage media comprising:
a module for controlling said processor to communicate a status packet from said second device to said first device;
a module for controlling said processor to communicate a reply to said status packet from said first device to said second device, wherein said reply includes a request for said data; and
a module for controlling said processor to communicate said data from said second device to said first device, after communicating said reply,
wherein said status packet, said reply and said data are formatted in accordance with a protocol that is common to both of said first device and said second device.

18. The storage media of claim 17, wherein said network includes a component that prevents communicating said reply from said first device to said second device unless said reply is solicited by said second device.

19. The storage media of claim 17, further comprising a module for controlling said processor to periodically communicate said status packet from said second device to said first device.

20. The storage media of claim 17, further comprising, a program module for controlling said processor to authenticate that said first device is authorized to access said data.

21. A method for exchanging data between a first device and a second device via a network, said method comprising:
communicating a status packet from said second device to said first device;
communicating a reply to said status packet from said first device to said second device, wherein said reply includes a request for said data;
communicating an identifier for said data from said second device to said first device;
communicating said identifier from said first device back to said second device; and
communicating said data from said second device to said first device, after said communicating of said identifier from said first device back to said second device,
wherein said status packet, said reply, said identifier, and said data are formatted in accordance with a protocol that is common to both of said first device and said second device.

22. An apparatus for exchanging data between a first device and a second device via a network, said apparatus comprising:
a module for communicating a status packet from said second device to said first device;
a module for communicating a reply to said status packet from said first device to said second device, wherein said reply includes a request for said data;
a module for communicating an identifier for said data from said second device to said first device;
a module for communicating said identifier from said first device back to said second device; and
a module for communicating said data from said second device to said first device, after said communicating of said identifier from said first device back to said second device,
wherein said status packet, said reply, said identifier, and said data are formatted in accordance with a protocol that is common to both of said first device and said second device.
